(19) United States
(12) Patent Application Publication
(10) Pub. No.: US 2011/0043719 A1
(43) Pub. Date: Feb. 24, 2011

(54) OPTICALLY TRANSMISSIVE COMPOSITE FILM FRAME

(76) Inventors: Kristin L. Thunhorst, Stillwater, MN (US); John A. Wheatley, Lake Elmo, MN (US); Shandon D. Hart, Corning, NY (US); Matthew E. Sousa, Eagan, MN (US); Andrew J. Ouderkirk, Singapore (SG); Erik J. Johnson, Oakdale, MN (US); Jay A. Esch, River Falls, WI (US); Nicholas G. Roland, Oakdale, MN (US); Andrew J. Henderson, Eagan, MN (US)

Correspondence Address: 3M INNOVATIVE PROPERTIES COMPANY, PO BOX 33427, ST. PAUL, MN, 55133-3427, US

(21) Appl. No.: 12/666,470

(22) PCT Filed: Jun. 30, 2008
(86) PCT No.: PCT/US08/68739

§ 371 Date: Nov. 16, 2010

Related U.S. Application Data
(60) Provisional application No. 60/947,776, filed on Jul. 3, 2007.

(51) Int. Cl. G02F 1/1335; F21V 7/22; F21V 9/14; H01J 9/24

(52) U.S. Cl. 349/58; 362/608; 362/19; 445/23; 445/24

(57) ABSTRACT

Optical display backlight assemblies having a transmissive optical film affixed to a frame which at least partially surrounds a backlight, are disclosed. The transmissive optical film can provide an increased bending resistance to the frame. The increase in bending resistance of the frame also increases the bending resistance of a display which incorporates the backlight assemblies. The optical film can be in tension after being affixed to the frame, and the tension in the film also can result in a flatter film surface with less sag. The film can be placed in tension prior to being affixed to the frame, the frame can be elastically distorted prior to affixing the film to impart tension to the film, or the film can develop tension by shrinkage after being affixed to the frame.

### CROSS REFERENCE TO RELATED APPLICATIONS

This application claims priority to U.S. Provisional Application No. 60/947,776, filed Jul. 3, 2007 which is herein incorporated by reference.

### BACKGROUND

Recent trends in the portable consumer electronics field have been directed toward higher portability through the reduction in size and weight of devices, while retaining the device functionality of larger, less portable devices. For example, laptop computers have continuously decreased in thickness and weight, to enable the consumer to more easily transport the computer; however, characteristics such as screen size and brightness, as well as battery use time are not to be compromised.

One of the components which contributes to the size and weight of laptop computers is the display screen (typically a liquid crystal display, or LCD), which is surrounded by an enclosure which serves as the top of the closed laptop. There have been continual efforts in the industry to increase the display screen area without compromising the display brightness and battery life and at the same time minimizing both the thickness and weight of the display.

A typical LCD screen used in a laptop computer contains, at the minimum, a LCD element, and a source to illuminate the display element, such as a backlight. The LCD element is attached to the backlight in most display screens, and a typical method of attaching the LCD element is by adhesive tape surrounding the edges of the backlight and the LCD. Additional standard components include, for example, one or more optical films that enhance the appearance of images displayed by the LCD element, by making efficient use of the light produced by the backlight. The LCD, backlight and additional films can also be enclosed within a metal frame, to protect the components and insure proper alignment within the display screen enclosure.

One of the methods used to reduce the thickness and weight of the LCD screen has been to reduce the thickness and weight of the LCD element, by reducing the thickness of the two optically transparent substrates (typically glass) which make up the display. However, decreasing the thickness of the glass makes the LCD element very fragile, and readily susceptible to breakage.

Another method used to reduce the thickness and weight of the LCD screen, has been to devise thinner and more energy efficient backlights. To this end, the industry standard CCFL (cold cathode fluorescent) bulbs have been replaced by more efficient light emitting diodes (LED) as light sources, using innovative schemes to maximize uniformity and brightness across the display area while minimizing both the thickness and weight of the backlight.

These and other efforts have resulted in ever thinner laptop computer displays, decreasing the thickness of the display from approximately 11 mm in the past, to a thickness of only 4 mm in some current commercially available displays. Unfortunately, these thinner displays have also been broken more frequently, due to inadvertent flexing of the display while opening or closing the laptop. Ever mindful of the desire for thinness and light weight, some manufacturers have resorted to expensive solutions directed toward rigidifying the enclosure of the display to protect the LCD panel, including for example, the use of carbon-fiber composites. Accordingly, it would be useful to provide a durable, cost-effective display of minimal weight and thickness.

### SUMMARY

Backlight assemblies are disclosed, which include a backlight, a frame, and a transmissive optical film. The backlight can have an aspect ratio of 20 or greater, and the frame can at least partially enclose the backlight. The frame can have a base, structural supporting ribs, a second transmissive optical film located at the base, or a combination of any of the base, structural supporting ribs, and second transmissive optical film. The transmissive optical film can be a composite optical film positioned adjacent to the backlight and affixed to the frame, and can be affixed in tension to the frame. The frame and the backlight assembly have an increased bending resistance compared to the bending resistance without the affixed film, and the increase in bending resistance of the frame can be a factor of 10 or more. The backlight assembly can be associated with a liquid crystal display, and the bending resistance of the display can be increased by at least a factor of 2.

Backlight assemblies are also disclosed which include a backlight which can have an aspect ratio greater than 20, a frame which can surround at least a portion of the backlight, and a transmissive optical film affixed to the frame in tension. The frame can have a base, structural supporting ribs, a second transmissive optical film located at the base, or a combination of any of the base, structural supporting ribs, and second transmissive optical film. The transmissive optical film can be a composite optical film positioned adjacent to the backlight and affixed to the frame. The transmissive optical film can further include at least one film selected from a polarizer, reflective polarizer, diffuser, reflector, partial reflector, asymmetric reflector and a structured surface film. The transmissive optical film can be held in tension prior to affixing the film to the frame; the transmissive optical film can exert a tensile force on the frame after being affixed to the frame. The frame can apply tension to the transmissive optical film after the film is affixed to the frame. The frame, and the backlight assembly, have an increased bending resistance compared to the bending resistance without the affixed film, and the increase in bending resistance of the frame can be a factor of 10 or more. The backlight assembly can be associated with a liquid crystal display, and the bending resistance of the display can be increased by at least a factor of 2.

Backlight assemblies are also disclosed which include a backlight, a frame which can surround at least a portion of the backlight, and a composite optical film affixed to the frame. The film can be affixed to the frame using an adhesive, including but not limited to a hotmelt adhesive, an epoxy adhesive and a reactive polyurethane adhesive. The composite optical film can be a thermoset polymeric film and can also include fibers; the fibers can be woven. The fibers can be organic fibers or inorganic fibers, and the inorganic fibers can be glass, ceramic, or glass-ceramic. The composite optical film can also be a laminate which can include a multilayer optical film, a birefringent film, a microstructure, an asymmetric reflective film, or a combination thereof. The backlight assembly can be associated with a liquid crystal display, and the backlight assembly can also be associated with a light emitting panel.

Methods of making light emitting panels are disclosed, where the method includes providing a frame, placing at least a portion of a planar light source within the frame, and affixing a transmissive optical film, held in tension, across the top opening of the frame. The method further discloses positioning a liquid crystal display module adjacent to the planar light source, either between the light source and the transmissive optical film, or next to the transmissive optical film and on the side opposite the light source.

A hollow backlight assembly is also disclosed, which includes a frame having a reflective surface surrounding at least a portion of a light source, and an asymmetric reflective film positioned over the opening of the frame. The hollow backlight assembly also includes a transmissive optical film adjacent to the asymmetric reflective film and affixed to the frame, to increase the bending resistance of the frame.

These and other aspects of the present application will be apparent from the detailed description below. In no event, however, should the above summaries be construed as limitations of the claimed subject matter, which subject matter is defined solely by the attached claims, as may be amended during prosecution.

### BRIEF DESCRIPTION OF THE DRAWINGS

Throughout the specification reference is made to the appended drawings, where like reference numerals designate like elements, and wherein:

FIG. 1a is a perspective representation of a laptop computer.

FIG. 1b is an exploded perspective representation of an LCD.

FIG. 2 is a cross-sectional view of a backlight assembly.

FIG. 3a is a perspective view of a frame within a backlight assembly of FIG. 2.

FIGS. 3b-d are top views of other embodiments of the frame of FIG. 3a.

FIG. 4a is a cross-sectional view through segment A-A′ of FIGS. 3b-3d.

FIG. 4b is another embodiment of the cross-sectional view of FIG. 4a.

FIG. 5a is a top view of one embodiment of the transmissive optical film.

FIG. 5b is a cross-sectional view of one method of attaching the film of FIG. 5a to the frame of FIGS. 3a-3d.

FIG. 5c is a cross-sectional view of another embodiment of FIG. 5b.

FIG. 6 is a perspective view of the frame used for computer modeling the frame stiffness.

FIGS. 7a-c are schematic views of a backlight assembly within an enclosure.

FIGS. 8a-b are cross-sectional views of a film support used with a frame in a backlight assembly.

FIGS. 8c-d are top and cross-sectional views of a spline for attaching a film under tension to a frame.

FIGS. 9a-h are schematic representations of several tensioning frame designs.

FIG. 10 is a cross-sectional view of a hollow backlight assembly.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure is applicable to optical displays including signs, displays, luminaires, and task lighting, and methods for improving the resistance of such displays to breakage during normal handling and operation of the displays. This improvement in the resistance to breakage is accomplished by increasing the relative bending resistance of the display. This increase in the bending resistance is accomplished by creating a lightweight structure that improves the rigidity of a frame enclosing portions of the display, preferably by use of a film with high modulus, which is incorporated into the frame design.

Although the description contained herein is directed toward a film used to increase the bending resistance of a frame, it is to be understood that material of any thickness being sufficiently optically transmissive is within the scope of the disclosure, including rigid sheets or panels. Also, although the description included herein refers to examples relating to backlit LCDs, the improvement in the structural rigidity of the display is equally applicable to any display or lighting panel that is prone to breakage by flexing, e.g. OLED displays, EL displays, Plasma displays, FED displays, luminaires, light boxes, task lights and the like. The term “backlight assembly” for the purposes of the present disclosure, means the collection and arrangement of components used to provide light and rigidity to a display such as an LCD or lighting panel such as a luminaire, light box, task light, sign and the like.

Unless otherwise indicated, references to “backlight assemblies” are also intended to apply to other extended area lighting devices that provide nominally uniform illumination in their intended application. Such other devices can provide either polarized or unpolarized outputs. Examples include light boxes, signs, channel letters, and general illumination devices designed for indoor (e.g. home or office) or outdoor use, sometimes referred to as “luminaires”.

Several additional benefits can arise from use of a film to increase the bending resistance of a frame used in an optical display. For example, a film held in tension to increase the bending resistance will also exhibit less sag in unsupported areas, and the film will be flatter. Particularly for optical films, flatness is desired to eliminate anomalies between regions of the film, such as can result from differing angles of reflection and refraction across the film surface.

Transmissive optical films have widespread use throughout the display industry. Exemplary transmissive optical films are polymeric films, including composite optical films. Examples of transmissive optical films include BEF, DBEF, DRPF (all available from 3M Company of St. Paul, Minn.), and gain diffusers, diffusers, compensation films, polarizers, collimating films, privacy films, colored films, simple clear films and the like. Further examples of transmissive optical films can be found, for example, in U.S. Pat. No. 5,882,774 (Jonza et al.) and U.S. Pat. No. 5,867,316 (Carlson et al.); U.S. Patent Publication Nos. 20060257679 (Benson et al.) and 20060257678 (Benson et al.); U.S. patent application Ser. Nos. 11/278,336 and 11/278,258; and also 60/939079 and 60/939,084, both filed on May 20, 2007.

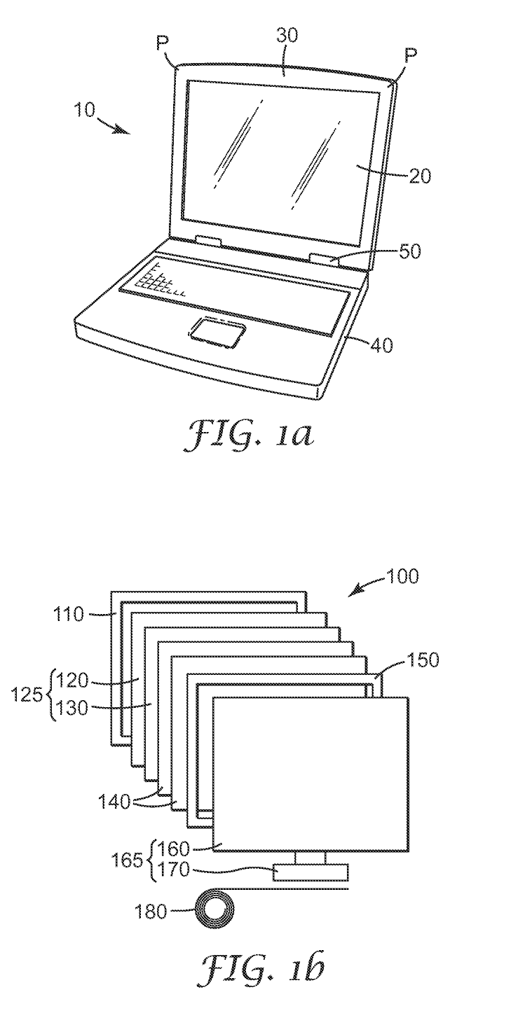

FIG. 1a shows a perspective view of a typical laptop computer 10 having display screen 20 housed in enclosure 30. Enclosure 30 is attached to computer 40 by a hinge 50. As the laptop computer 10 is opened and closed, force is generally applied at one or both points “P” by the fingertips. Depending on the magnitude of the applied force, the friction of the hinge, and the strength of the enclosure, the display area can flex or undergo some bending motion, potentially leading to breakage of the display.

FIG. 1b shows an exploded perspective view of the various components in an LCD 100, housed in enclosure 30 of FIG. 1a. A metal frame 110 provides support and alignment for backlight 125 which includes reflector 120, light guide 130 and a light source (not shown). Light guide 130 can include solid or hollow light guides of any design, light guides are typically used to distribute light from the light source uniformly over the surface of the LCD. The light source can include any of the light sources mentioned previously, including CCFL, LED and the like.

Unless otherwise indicated, references to LEDs are also intended to apply to other sources capable of emitting bright light, whether colored or white, and whether polarized or unpolarized, in a small emitting area. Examples include semiconductor laser devices, and sources that utilize solid state laser pumping.

The term “LED” refers to a diode that emits light, whether visible, ultraviolet, or infrared. It includes incoherent encased or encapsulated semiconductor devices marketed as “LEDs”, whether of the conventional or super radiant variety. If the LED emits non-visible light such as ultraviolet light, and in some cases where it emits visible light, it is packaged to include a phosphor (or it can illuminate a remotely disposed phosphor) to convert short wavelength light to longer wavelength visible light, in some cases yielding a device that emits white light. An “LED die” is an LED in its most basic form, i.e., in the form of an individual component or chip made by semiconductor processing procedures. The component or chip can include electrical contacts suitable for application of power to energize the device. The individual layers and other functional elements of the component or chip are typically formed on the wafer scale, and the finished wafer can then be diced into individual piece parts to yield a multiplicity of LED dies. An LED can also include a cup-shaped reflector or other reflective substrate, encapsulating material formed into a simple dome-shaped lens or any other known shape or structure, extractor(s), and other packaging elements, which elements can be used to produce a forward-emitting, side-emitting, or other desired light output distribution.

Returning to FIG. 1b, LCD module 165 includes LCD panel 160 and drive electronics 170, and LCD module 165 is attached to metal frame 110 using tape 180, and is separated from backlight 125 by polycarbonate retainer 150 and optical films 140. In a typical laptop computer, the LCD module is disposed within an enclosure which is hinged at one edge, to provide a pivotable computer screen. The LCD module is secured in some fashion within this enclosure to prevent movement, for example by using tabs or posts that can be molded into the interior of the enclosure. There can also be resilient padding within the enclosure, which provides additional protection and support for the fragile LCD module.

Regardless of the method used to secure the LCD module, forces are applied to the enclosure by both the hinge mechanism and the user's hands as the computer is opened, used and closed. These forces are transferred to the LCD module, and ultimately to the fragile LCD glass, which is surrounded by the enclosure. This can result in damage to the LCD glass. One method of reducing the forces transferred to the LCD module is by sufficiently increasing the rigidity of the enclosure by using thicker, stiffer, or higher modulus materials. If weight, cost, and size of the laptop were not a concern, a sufficiently rigid enclosure could be produced to essentially eliminate the transference of forces on the enclosure to the LCD module. However, because consumers more readily accept light and thin laptop computers than heavy and thick ones, the computer screen is preferably made more rigid in other ways.

The rigidity of LCD module 100, when assembled, arises from a combination of the properties of the various components which comprise the module and from the manner in which they are assembled. If the module is taped together, for example, with a pressure-sensitive adhesive (PSA) adhesive backed tape, there is limited synergistic increase in the rigidity of the module due to the assembly system. Instead, the rigidity of the assembled module is substantially drawn from the most rigid component. A force imparted normal to one surface of the module can cause the module components to shift relative to each other to accommodate the applied force, until no further relative motion is possible. At this point, the applied stresses will be directly applied to the most rigid component, ultimately causing that component to fail by, for example, fracturing. In the LCD module described above, the most rigid component is typically the glass used in the LCD, and as such, the result of applying excessive force to the enclosure results in breakage of the LCD module. One benefit of the present disclosure is the reduced likelihood of damage to an LCD, module and panel.

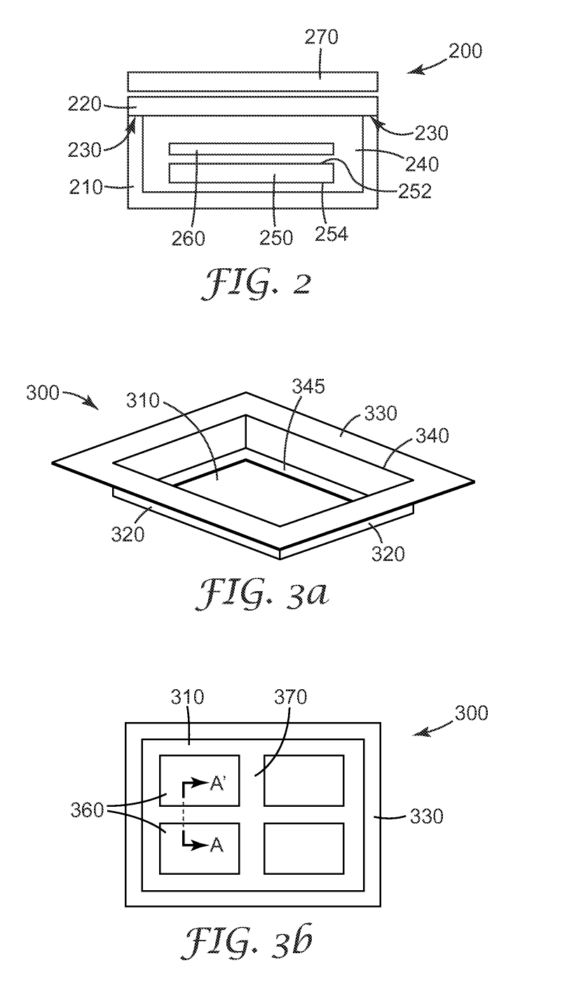

Turning now to FIG. 2, several components of the present disclosure are depicted. Backlight assembly 200 includes frame 210 and transmissive optical film 220. Transmissive optical film 220 is affixed to frame 210 at affixing region 230, thereby creating a cavity 240. Frame 210 and the affixed transmissive optical film 220 can act in concert to increase the rigidity, and therefore the bending resistance of backlight assembly 200. A backlight 250 having first surface 252 and second surface 254 at least one of which is configured and arranged to emit light, and optional optical films 260 are disposed within cavity 240, and LCD module 270 is disposed adjacent to transmissive optical film 220. LCD module 270 can alternatively be disposed within the cavity, between backlight 250 and transmissive optical film 220. The increase in the bending resistance of the frame by use of a film is particularly useful for frames which have a high aspect ratio, such as greater than 20. The term “aspect ratio” for the purposes of the present disclosure, means the largest lateral dimension of the frame cavity divided by the depth of the cavity. For example, a frame cavity having a largest lateral dimension of 40 cm, and a depth of 1 cm, would have an aspect ratio of 40.

The rigidity of the backlight assembly can be related to (a) the rigidity of the frame, (b) the rigidity of the film, and (c) the manner in which they are attached or affixed together. The following paragraphs will describe the frame and ways to make it more rigid, the film and ways to make it more rigid, and ways to assemble the frame and film to make a rigid assembly. To this end, each of the components in FIG. 2 will now be described in greater detail.

### Rigidity of the Frame

Frame 210 is intended to accommodate alignment and placement of the several components of the display. The frame can contribute to the rigidity of the frame/polymer structure, and so design changes to the frame affect the rigidity of the backlight assembly and the whole display. Increases in the rigidity of the frame and backlight assembly lead to an overall increase in the rigidity of the whole display; however, the overall rigidity increase may not be directly proportional to the increase in rigidity of any one component. For example, a factor of 50 improvement in the rigidity of the frame may only lead to a doubling of the rigidity of the whole display, due to interactions of the other components. The frame can be constructed of one or more of several types of material, depending on the relative ease of construction, cost of materials, and size/weight considerations. The frame provides a three dimensional structure surrounding the cavity, and provides a location for disposing the backlight and other components related to the display in a desired order within the cavity.

The frame material can be comprised of a metal such as aluminum, titanium, magnesium, steel, metal alloys, and the like. The frame material can also be made from non-metallic transparent, opaque, or transflective materials, such as: plastics, composites including carbon-fiber and/or glass-fiber composites, glasses and the like. The frame can be either a structure separate from the enclosure, or it can be formed as an integral part of the enclosure.

In some embodiments, suitable frame materials preferably have a high modulus of elasticity, for example greater than about 10⁵N/mm², while still being able to be readily formed into a three-dimensional structure. Examples of such materials include sheet metals, including cold-rolled metals, such as aluminum, steel, stainless steel, tin and other metals in thin sheet form. Sheet metals can be readily shaped or formed by common metal forming techniques, such as by stamping. Optionally, the frame can be formed from a cast metal, including a die-cast aluminum or aluminum alloys. The thickness of the frame material used in commercially available displays is preferably less than 1 mm thick, for example, 0.2 mm thick.

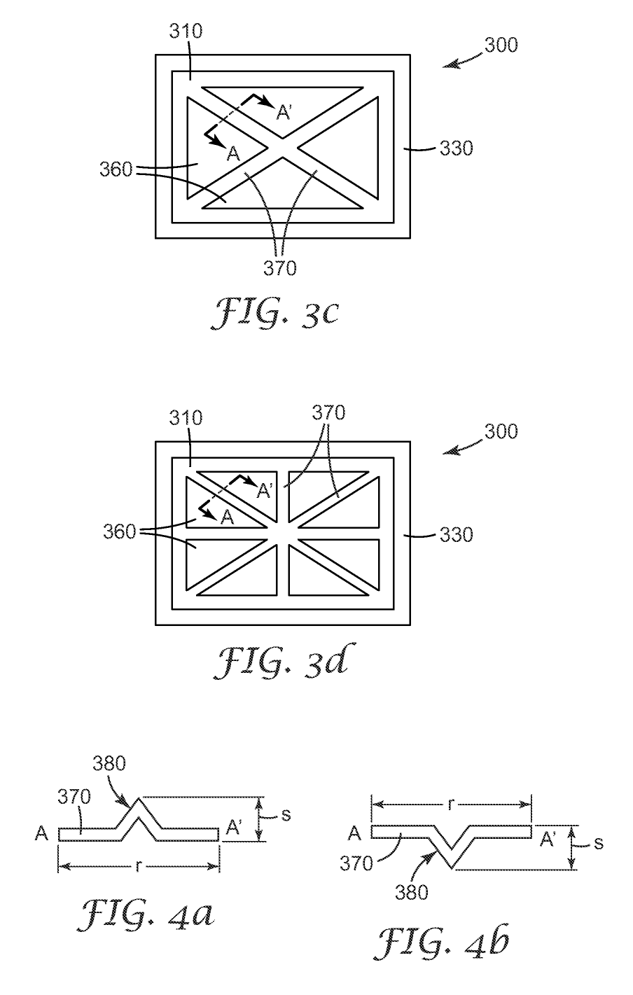

FIGS. 3a-d depict different design examples of frames formed by the aforementioned techniques. FIG. 3a shows frame 300 having base 310 disposed at the back of the frame, and back ledge 345 located along the perimeter of base 310. Back ledge 345 confines the structures in place within frame 300 adjacent base 310. Sides 320 adjoin back ledge 345, and flange 330 surrounds front perimeter 340 defined by sides 320 of the frame. Flange 330 can alternatively be located within the front perimeter 340 (i.e. in an orientation similar to back ledge 345), and located either at the front perimeter 340, or at a position between the front perimeter 340 and back ledge 345. Base 310 can be a solid base with no openings within it, and in this case back ledge 345 extends across the entire base 310. Base 310 can also be open and devoid of substantially all material. In this case back ledge 345 is not present, and base 310 forms an opening similar to that defined by front perimeter 340. In some embodiments, base 310 can be parallel to flange 330 so that the separation (indicated by sides 320) between the front perimeter 340 and base 310 is uniform across frame 300. In other embodiments, base 310 can instead be stepped, canted, or curved relative to flange 330 so that the separation between the front perimeter 340 and base 310 varies across frame 300, e.g. as in a wedge shape. As shown in FIGS. 3b-d, base 310 can also be provided with openings 360 of various shapes and sizes, separated by ribs 370.

One modification that can improve the design of the frame is to reduce the weight of the frame while keeping strength either the same or greater. A parameter that can describe this relationship is the strength to weight ratio. An increased strength to weight ratio can result by using a ribbed design similar to those shown in FIGS. 3b-d. The strength to weight ratio can also be improved by removing material in various locations in the base, because it can have a minimal impact on the rigidity of the structure, while reducing the weight of the frame.

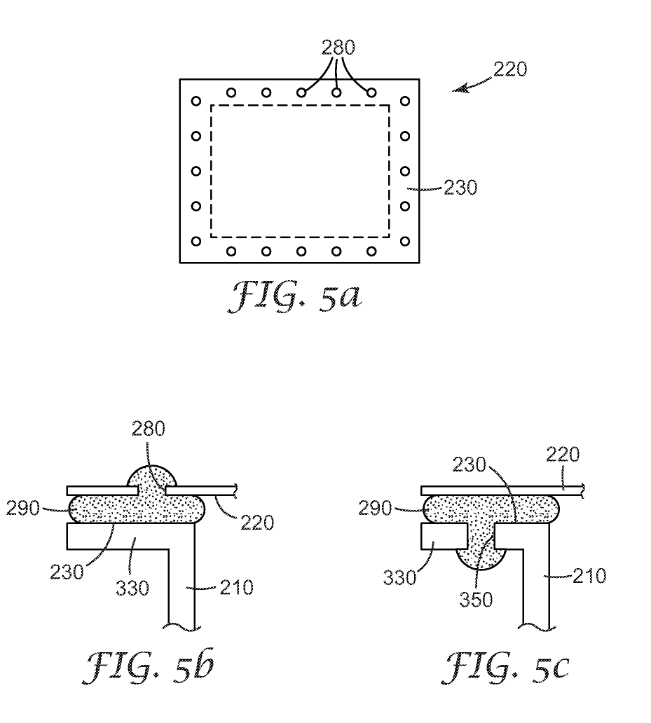

As shown in FIGS. 4a-b, which are cross sections along the line A-A′ in FIGS. 3b-d, rib 370 having a width “r”, can have stiffening structure 380 having a height “s”, that adds to the resistance to bending of rib 370. For example, some or all of the ribs can have one or more central portions parallel to the sides of the rib that are bent out of plane, forming stiffening structure 380. The stiffening structures can project into or out of cavity 240 of backlight assembly 200. This stiffening structure increases the stiffness of the rib, and also results in a concomitant increase in the stiffness of the frame. Stiffening structure 380 can be formed in any or all of the ribs 370, and can also be formed on back ledge 345 or flange 330. More than one stiffening structure can be formed in any rib (i.e. several parallel structures 380 within the rib), and although stiffening structure 380 is shown in FIGS. 4a-b as having sharp angles, it is to be understood that the structure can be any shape, for example a rounded shape, and still perform the same function of stiffening the rib.

### Rigidity of the Film

Turning to another component depicted in FIG. 2, the transmissive optical film will now be described in further detail. As mentioned previously, the transmissive optical film acts in concert with the frame to increase the rigidity of the backlight assembly. Light output from the backlight leaves the backlight assembly through the optically transmissive polymeric film.

The transmissive optical film can be a composite optical film having a first layer comprising fibers embedded within a polymer matrix, and optionally a second layer attached to the first layer. The fibers can be inorganic fibers, organic fibers or a combination of inorganic and organic fibers. Suitable first layer films are described in U.S. patent application Ser. No. 11/278,346, filed on Jan. 23, 2007, and other suitable first layer films are also known in the art. Although a composite optical film can have advantages such as a better coefficient of thermal expansion (CTE) and lower creep than optical films that are not composites, in some applications a film which is not a composite may be acceptable. The second layer, if provided, can be the same as the first layer, or different.

The second layer, if provided, could be a structured (or microstructured) surface film such as Brightness Enhancement Film (BEF) to provide brightness enhancement, or other films including reflective polarizers including interference type, blend polarizers, wire grid polarizers; other structured surfaces including turning films, retroreflective cube corner films; diffusers such as surface diffusers, gain diffuser structured surfaces, or structured bulk diffusers; antireflection layers, hard coat layers, stain resistant hard coat layers, louvered films, absorptive polarizers, partial reflectors, asymmetric reflectors, wavelength selective filters, films having localized optical or physical light transmission regions including perforated mirrors; compensation films, birefringent or isotropic monolayers or blends, as well as bead coatings. For example, a list of additional coatings or layers is discussed in further detail in U.S. Pat. No. 6,459,514 (Jonza) and U.S. Pat. No. 6,827,886 (Neavin et al.). The second layer can also be an additional composite optical film. Optionally, the first layer can also have any of the surface structures described above.

The transmissive optical film can optionally be laminated to, or be an integral part of, a light guide. For example, light can be injected into the transmissive optical film, or the transmissive optical film/light guide combination, along an edge of a film having extraction features including grooves, ridges or printed dots on one or both surfaces. The extraction features permit light to escape the interior of the film from one or both surfaces of the film. Extraction structures corresponding to light guides can be found, for example, in U.S. patent application Ser. No. 11/278,336.

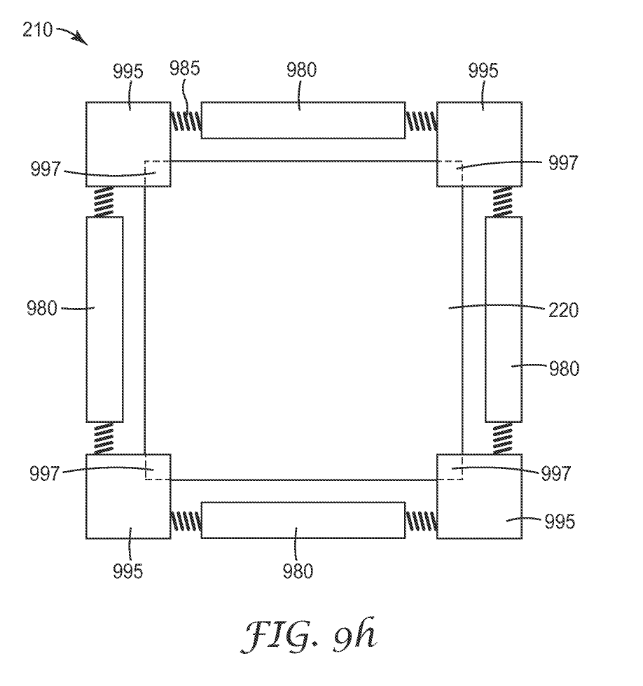

In another embodiment, the transmissive optical film is incorporated in a hollow backlight 1000 as shown in FIG. 10. The hollow backlight can, for example, be an asymmetric reflective film having an approximately 11% transmission to improve light uniformity, as described in co-owned U.S. Patent Application Ser. Nos. 60/939,079, 60/939,082, 60/939,083, 60/939,084, and 60/939,085, all filed on May 20, 2007. In the hollow backlight of FIG. 10, frame 210 is provided with reflective surface 1030 and an LED 1040. LED 1040 can be any of the semiconductor light sources described herein, and can also be located externally to frame 210, providing it is configured to provide light through an opening (not shown) in frame 210 to the reflective interior of the hollow backlight. In some embodiments, frame 210 can include a light collimating structure (not shown) which partially surrounds LED 1040 and efficiently directs light into the hollow backlight cavity. Examples of suitable light collimating structures include flat, curved or segmented baffles or wedges; shaped optics such as parabolas, paraboloids, or compound parabolic concentrators; and the like. Reflective surface 1030 can be the surface of the frame, or a separate highly reflective film attached to the frame. Asymmetric reflective film 1020 is positioned adjacent to transmissive optical film 220 and attached thereto, to prevent excessive sag of asymmetric reflective film 1020. In one embodiment, reflective surface 1030 can be a semispecular reflector such as a bead coated Enhanced Specularly Reflective (ESR) film as described, for example, in U.S. patent application Ser. No. 11/467,326. In another embodiment, asymmetric reflective film 1020 can be replaced instead with a partially reflective film having a transmission greater than the approximately 11% transmission of the asymmetric reflective film, for example 20%, 30%, 40% or more can be used in the hollow backlight in some instances.

In another embodiment, phosphor particles can be incorporated either within the transmissive optical film, or within one or more additional layers coated on the surface of the film. In this embodiment, the phosphor-loaded transmissive optical film can be used to down-convert light from a UV or blue LED as shown for example, in U.S. Patent Publication No. 20040145913 (Ouderkirk et al.). The phosphor loaded film can also be used with one or more wavelength selective transmissive films to improve efficiency of light utilization. Examples of wavelength selective films are shown, for example, in U.S. Pat. No. 6,010,751 (Shaw et al.), U.S. Pat. No. 6,172,810 (Fleming et al.) and U.S. Pat. No. 6,531,230 (Weber et al.).

The transmissive optical film can be a film, sheet or plate of polymer. Of particular interest are films that are stiff. In some embodiments, the transmissive optical film can be a stiff material having a high elastic modulus, for example greater than about 10⁴ N/mm² One approach for improving the stiffness of an optical film is to increase the modulus by including reinforcing fibers within the film. “Composite optical film”, for the purposes of the present disclosure, means a transmissive optical film that has fibers incorporated within a polymer matrix, and where the fibers or particles can be organic or inorganic fibers. The composite optical film can optionally include either organic or inorganic particles in addition to the fibers. Some exemplary fibers are matched in refractive index to the surrounding material of the film so that there is little, or no, scatter of the light passing through the film. Although it can be desirable in many applications that the composite optical films are thin, e.g. less than about 0.2 mm, there is no particular limitation to the thickness. In some embodiments it can be desirable to combine the advantages of composite materials and greater thickness, for example creating thick plates used in LCD-TV's that could be 0.2-10 mm thick. The term “optical film” as used with respect to the present disclosure, can also include thicker optical plates or lightguides.

One embodiment of a reinforced transmissive optical film comprises a composite optical film of organic fibers disposed within a polymeric matrix. Another embodiment of a reinforced transmissive optical film comprises a composite optical film of inorganic fibers disposed within a polymeric matrix. The case of inorganic fibers disposed within a polymeric matrix are described below; however, it is to be understood that organic fibers could be substituted for inorganic fibers in some embodiments. The use of organic fibers can provide an additional optical effect, if birefringent organic fibers are used. Birefringent organic fibers are described in, for example, U.S. Patent Publication Nos. 20060193577 (Ouderkirk et al.) and 20060194487 (Ouderkirk et al.).

The orientation of the fiber (the “fiber axis”) within the polymeric matrix can be varied, to influence the mechanical properties of the reinforced transmissive optical film. The fiber axis can either be oriented at 0 and 90 degrees relative to the frame, or at some other angle deemed advantageous to the mechanical design and bending resistance of the overall frame/film structure. Further, the fibers comprising the fabric do not have to be oriented at 0 and 90 degrees within the fabric. Orienting the fibers along the principal axes or diagonals of the display can provide particular advantage.

The inorganic fibers can be formed of glass, ceramic or glass-ceramic materials, and can be arranged within the matrix as individual fibers, in one or more tows or in one or more woven layers. The fibers can be arranged in a regular pattern or an irregular pattern. Several different embodiments of reinforced polymeric layers are discussed in greater detail in U.S. Patent Publication No. 20060257678 (Benson et al.). The fibers arranged in tows or woven fabrics are preferably continuous fibers rather than chopped or staple fibers. Although short chopped fibers, staple fibers or even particulates can be used to modify mechanical properties including the coefficient of thermal expansion (CTE) and warp resistance, continuous fiber constructions can modify the modulus and tensile properties to a greater extent. As a result, continuous fiber constructions allow the fiber to bear some of the stress within the film, when the frame is bent.

The refractive indices of the matrix and the fibers can be chosen to match or not match. In some exemplary embodiments, it can be desirable to match the refractive indices so that the resulting film is nearly, or completely, transparent to the light from the light source. In other exemplary embodiments, it can be desirable to have an intentional mismatch in the refractive indices to create either specific color scattering effects or to create diffuse transmission or reflection of the light incident on the film. Refractive index matching can be achieved by selecting an appropriate fiber reinforcement that has an index close to the same as that of the resin matrix, or by creating a resin matrix that has a refractive index close to, or the same as, that of the fibers.

The refractive indices in the x-, y-, and z-directions for the material forming the polymer matrix are referred to herein as n₁ₓ, m_{1y} and n_{1z}. Where the polymer matrix material is isotropic, the x-, y-, and z-refractive indices are all substantially matched. Where the matrix material is birefringent, at least one of the x-, y- and z-refractive indices is different from the others. The material of the fibers is typically isotropic. Accordingly, the refractive index of the material forming the fibers is given as n₂. The fibers can, however, be birefringent.

In some embodiments, it can be desired that the polymer matrix be isotropic, i.e. n₁ₓ≈n_{y≈n}_{1z}≈n₁. Two refractive indices are considered to be substantially the same if the difference between the two indices is less than 0.05, preferably less than 0.02 and more preferably less than 0.01. Thus, the material is considered to be isotropic if no pair of refractive indices differs by more than 0.05, preferably less than 0.02. Furthermore, in some embodiments it is desirable that the refractive indices of the matrix and the fibers be substantially matched. Thus, the refractive index difference between the matrix and the fibers, the difference between n₁ and n₂ should be small, at least less than 0.03, preferably less than 0.01 and more preferably less than 0.002.

In other embodiments, it can be desired that the polymer matrix be birefringent, in which case at least one of the matrix refractive indices is different from the refractive index of the fibers. In embodiments where the fibers are isotropic, a birefringent matrix results in light in at least one polarization state being scattered by the reinforcing layer. The amount of scattering depends on several factors, including the magnitude of the refractive index difference for the polarization state being scattered, the size of the fibers and the density of the fibers within the matrix. Furthermore, the light can be forward scattered (diffuse transmission), backscattered (diffuse reflection), or a combination of both. Scattering of light by a fiber reinforced layer is discussed in greater detail in U.S. Patent Publication No. 20060257678 (Benson et al.).

Suitable materials for use in the polymer matrix include thermoplastic and thermosetting polymers that are transparent over the desired range of light wavelengths. In some embodiments, it can be particularly useful that the polymers be non-soluble in water, the polymers can be hydrophobic or can have a low tendency for water absorption. Further, suitable polymer materials can be amorphous or semi-crystalline, and can include homopolymer, copolymer or blends thereof. Example polymer materials include, but are not limited to, poly(carbonate) (PC); syndiotactic and isotactic poly(styrene) (PS); C1-C8 alkyl styrenes; alkyl, aromatic, aliphatic and ring-containing (meth)acrylates, including poly(methylmethacrylate) (PMMA) and PMMA copolymers; ethoxylated and propoxylated (meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate) (PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends. The term (meth)acrylate is defined as being either the corresponding methacrylate or acrylate compounds. These polymers can be used in an optically isotropic form.

In some product applications, it is important that film products and components exhibit low levels of fugitive species (low molecular weight, unreacted, or unconverted molecules, dissolved water molecules, or reaction byproducts). Fugitive species can be absorbed from the end-use environment of the product or film, e.g. water molecules can be present in the product or film from the initial product manufacturing or can be produced as a result of a chemical reaction (for example a condensation polymerization reaction). An example of small molecule evolution from a condensation polymerization reaction is the liberation of water during the formation of polyamides from the reaction of diamines and diacids. Fugitive species can also include low molecular weight organic materials such as monomers, plasticizers, etc.

Fugitive species are generally lower molecular weight than the majority of the material comprising the rest of the functional product or film. Product use conditions might, for example, result in thermal stress that is differentially greater on one side of the product or film. In these cases, the fugitive species can migrate through the film or volatilize from one surface of the film or product causing concentration gradients, gross mechanical deformation, surface alteration and, sometimes, undesirable out-gassing. The out-gassing could lead to voids or bubbles in the product, film or matrix, or problems with adhesion to other films. Fugitive species can, potentially, also solvate, etch or undesirably affect other components in product applications.

Several of these polymers can become birefringent when oriented. In particular, PET, PEN, and copolymers thereof, and liquid crystal polymers, manifest relatively large values of birefringence when oriented. Polymers can be oriented using different methods, including extrusion and stretching. Stretching is a particularly useful method for orienting a polymer, because it permits a high degree of orientation and can be controlled by a number of easily controllable external parameters, such as temperature and stretch ratio.

The matrix can be provided with various additives to provide desired properties to the optically transmissive polymeric film. For example, the additives can include one or more of the following: an anti-weathering agent, UV absorbers, a hindered amine light stabilizer, an antioxidant, a dispersant, a lubricant, an anti-static agent, a pigment or dye, a phosphor, a nucleating agent, a flame retardant and a blowing agent.

Some exemplary embodiments can use a polymer matrix material that is resistant to yellowing and clouding with age. For example, some materials such as aromatic urethanes become unstable when exposed long-term to UV light, and change color over time. It can be desired to avoid such materials when it is important to maintain the same color for a long term.

Other additives can be provided to the matrix for altering the refractive index of the polymer or increasing the strength of the material. Such additives can include, for example, organic additives such as polymeric beads or particles and polymeric nanoparticles. In some embodiments, the matrix is formed using a specific ratio of two or more different monomers, where each monomer is associated with a different final refractive index when polymerized. The ratios of the different monomers determine the refractive index of the final resin.

In other embodiments, inorganic additives can be added to the matrix to adjust the refractive index of the matrix, or to increase the strength and/or stiffness of the material. Inorganic additives can also affect the matrix durability, scratch resistance, CTE or other thermal properties. For example, the inorganic material can be glass, ceramic, glass-ceramic or a metal-oxide. Any suitable type of glass, ceramic or glass-ceramic, discussed below with respect to the inorganic fibers, can be used. Suitable types of metal oxides include, for example, titania, alumina, tin oxides, antimony oxides, zirconia, silica, mixtures thereof or mixed oxides thereof. Such inorganic materials can be provided as nanoparticles, for example milled, powdered, bead, flake or particulate in form, and distributed within the matrix. Nanoparticles can be synthesized, for example, using gas-phase or solution-based processing. The size of the particles is preferably lower than about 200 nm, and can be less than 100 nm or even 50 nm to reduce scattering of the light passing through the matrix. The additives can have functionalized surfaces to optimize the dispersion and/or the rheology and other fluid properties of the suspension, or to react with the polymer matrix. Other types of particles include hollow shells, for example hollow glass shells.

Any suitable type of inorganic material can be used for the fibers. The fibers can be formed of a glass that is substantially transparent to the light passing through the film. Examples of suitable glasses include glasses often used in fiberglass composites such as E, C, A, S, R, and D glasses. Higher quality glass fibers can also be used, including, for example, fibers of fused silica and BK7 glass. Suitable higher quality glasses are available from several suppliers, such as Schott North America Inc., Elmsford, N.Y. It can be desirable to use fibers made of these higher quality glasses because they are purer and so have a more uniform refractive index and have fewer inclusions, which leads to less scattering and increased transmission. Also, the mechanical properties of the fibers are more likely to be uniform. Higher quality glass fibers are less likely to absorb moisture, and thus the film becomes more stable for long term use. Furthermore, it can be desirable to use a low alkali glass, since alkali content in glass increases the absorption of water.

Discontinuous reinforcements, such as particles or chopped fibers, can be preferred in polymers that need stretching or in certain other forming processes. Extruded thermoplastics filled with chopped glass, for example, as described in U.S. patent application Ser. No. 11/323,726, incorporated herein by reference, can be used as the fiber-filled reinforcing layer. For other applications, continuous glass fiber reinforcements (i.e. weaves or tows) can be preferred since these can lead to a larger reduction in the coefficient of thermal expansion (CTE) and a greater increase in modulus.

Another type of inorganic material that can be used for the fiber is a glass-ceramic material. Glass-ceramic materials generally comprise 95%-98% vol. of very small crystals, with a size smaller than 1 micron. Some glass-ceramic materials have a crystal size as small as 50 nm, making them effectively transparent at visible wavelengths, since the crystal size is so much smaller than the wavelength of visible light that virtually no scattering takes place. These glass-ceramics can also have very little, or no, effective difference between the refractive index of the glassy and crystalline regions, making them visually transparent. In addition to the transparency, glass-ceramic materials can have a rupture strength exceeding that of glass, and some types are known to have coefficients of thermal expansion of zero or that are even negative in value. Glass-ceramics of interest have compositions including, but not limited to, Li₂O—Al₂O₃—SiO₂, CaO—Al₂O₃—SiO₂, Li₂O—MgO—ZnO—Al₂O₃—SiO₂, Al₂O₃—SiO₂, and ZnO—Al₂O₃—ZrO₂—SiO₂, Li₂O—Al₂O₃—SiO₂, and MgO—Al₂O₃—SiO₂.

Some ceramics also have crystal sizes that are sufficiently small that they can appear transparent if they are embedded in a matrix polymer with an index of refraction appropriately matched. The Nextel™ Ceramic fibers, available from 3M Company, St. Paul, Minn., are examples of this type of material, and are available as thread, yarn and woven mats. Suitable ceramic or glass-ceramic materials are described further in Chemistry of Glasses, 2^{nd} Edition (A. Paul, Chapman and Hall, 1990) and Introduction to Ceramics, 2^{nd} Edition (W. D. Kingery, John Wiley and Sons, 1976), the relevant portions of both of which are incorporated herein by reference.

In some exemplary embodiments, it can be desirable not to have perfect refractive index matching between the matrix and the fibers, so that at least some of the light is diffused by the fibers. In some of such embodiments, either or both of the matrix and fibers can be birefringent, or both the matrix and the fibers can be isotropic. Depending on the size of the fibers, the diffusion arises from scattering or from simple refraction. Diffusion by a fiber is non-isotropic: light can be diffused in a direction lateral to the axis of the fiber, but is not diffused in an axial direction relative to the fiber. Accordingly, the nature of the diffusion is dependent on the orientation of the fibers within the matrix. If the fibers are arranged, for example, parallel to the x-axis, then the light is diffused in directions parallel to the y- and z-axes.

In addition, the matrix can be loaded with diffusing particles that isotropically scatter the light. Diffusing particles are particles of a different refractive index than the matrix, often a higher refractive index, having a diameter up to about 10 μm. These can also provide structural reinforcement to the composite material. The diffusing particles can be, for example, metal oxides such as were described above for use as nanoparticles for tuning the refractive index of the matrix. Other suitable types of diffusing particles include polymeric particles, such as polystyrene or polysiloxane particles, or a combination thereof. The diffusing particles can also be hollow glass spheres such as type S60HS Glass Bubbles, produced by 3M Company, St. Paul, Minn. The diffusing particles can be used alone to diffuse the light, or can be used along with non-index-matched fibers to diffuse the light, or can be used in conjunction with the structured surface to diffuse and re-direct light.

Some exemplary arrangements of fibers within the matrix include yarns, tows of fibers or yarns arranged in one direction within the polymer matrix, a fiber weave, a non-woven, chopped fiber, a chopped fiber mat (with random or ordered formats), or combinations of these formats. The chopped fiber mat or nonwoven can be stretched, stressed, or oriented to provide some alignment of the fibers within the nonwoven or chopped fiber mat, rather than having a random arrangement of fibers. Furthermore, the matrix can contain multiple layers of fibers: for example the matrix can include more layers of fibers in different tows, weaves or the like. In one specific embodiment, the fibers are arranged in two layers.

### Affixing Film and Frame

Returning to FIG. 2 and FIGS. 3a-d, affixing region 230, provides the mechanical link between transmissive optical film 220 and frame 210, by joining the film and frame together in one or more locations. This mechanical link enables backlight assembly 200 to exhibit higher resistance to bending, as opposed to current backlight assemblies which lack this frame rigidifying structure. The transmissive optical film can be affixed to the front surface of the frame, the back surface of the frame, a position intermediate the front and back surface of the frame, both surfaces of the frame, or some combination of front, back and intermediate surface. In one embodiment, the transmissive optical film can be a sleeve (not shown) which surrounds the frame on the front, back, and at least two sides. The sleeve can be affixed to the frame by shrinking the transmissive optical film, expanding the frame, or a combination of both, as described elsewhere. In some instances, a film affixed to the back surface of the frame can be a polymeric film or a polymeric composite film which does not transmit light, but instead can be a translucent, diffusive, opaque or even a reflective film. The film(s) can be affixed on a continuous basis around the frame, or at two or more areas around the frame.

In one embodiment, affixing region 230 is located on flange 330 surrounding frame 210 along front perimeter 340. The transmissive optical film can be affixed to flange 330 by known methods, including adhesives and mechanical devices such as crimping the frame around the film, using a flexible gasket as a spline to capture the film, or ultrasonic welding to retain the film. The film can be affixed to the frame along the entire perimeter, or at selected intervals around the perimeter, e.g. at the four corners of the frame. It is preferable to affix the film to the frame in a continuous manner along the entire perimeter. Regardless of the method of attachment, the film should not significantly move relative to the frame at the affixing region, upon application of forces encountered in the preparation and use of a backlight assembly. Adhesives having a high modulus of elasticity are preferred, such as hot melt adhesives and thermosetting adhesives including epoxies and the like, to form the bond between the film and the frame in the affixing region. Examples of high modulus adhesives include Scotch-Weld™ Epoxy adhesives such as DP100+ and DP100NS, and Scotch-Weld™ Polyurethane Reactive Adhesives such as TS115 and TS230, available from 3M Company of St. Paul, Minn.

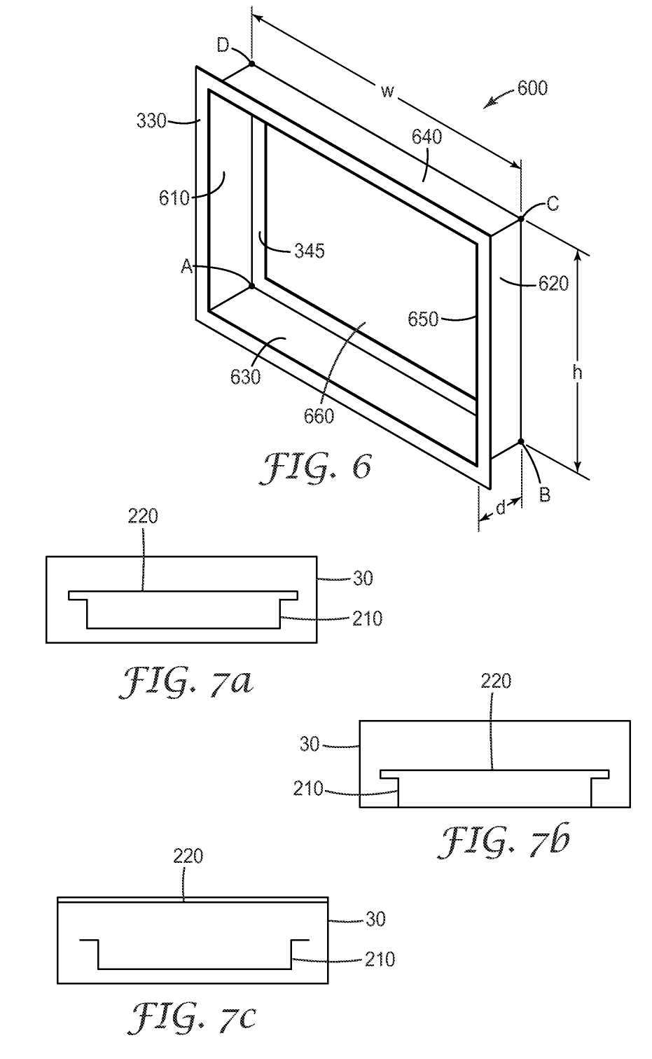

In another embodiment, shown in FIGS. 5a-c, transmissive optical film 220 has a plurality of perforations 280 in affixing region 230. Adhesive 290 applied within the affixing region 230 on flange 330 can flow through perforations 280, providing additional mechanical bonding of the transmissive optical film to frame 210, as shown in FIG. 5b. In some embodiments a perforated film can be susceptible to stress-cracking, so an alternative embodiment is shown in FIG. 5c, where flange 330 of frame 210 has perforations 350 to permit flow of adhesive 290 in affixing region 230, effectuating a similar increase in mechanical bonding.

In one embodiment, the transmissive optical film is held in tension prior to being affixed to the frame. The tension can be applied to the film in any manner known in the art, such as by gripping the edges of the film and applying tension to pull the edges apart. This application of tension (stress) induces a strain within the film, usually expressed as a strain percentage. The externally applied tension is maintained on the film until a bond is formed between the frame and the transmissive optical film (i.e. when the film becomes affixed to the frame). The external tension can then be removed, and the transmissive optical film is held in tension by the frame through the bond which has been formed. The result of affixing this pre-tensioned film to the frame is also to increase the bending resistance of the frame/film assembly.

In another embodiment, the level of tension applied to the film is selected to improve the flatness of the film when attached to the frame. Although any suspended body will sag somewhat due to its weight, the application of tension can minimize this sag, thereby improving flatness of the film. Flatness of a film becomes particularly important when the film is used for display applications such as in laptops and handheld devices. Slight variations in the flatness due to warping, wrinkling or sag within the film can produce undesirable optical artifacts, particularly if the film participates in the transmission of an image, through refraction or reflection of light. Generally, the maximum amount of sag that would be acceptable for optical applications such as a laptop computer, is such that the frame cannot be flexed appreciably before the film begins to develop tension sufficient to resist further bending of the film/frame combination. Once the frame flexes slightly, tension begins to develop in the film to resist further flexure.

In another embodiment, the flatness of the transmissive optical film can be controlled by the way that the film and frame are positioned as the film is affixed to the frame. For example, the film and frame can be assembled on a flat surface which is equipped with a device or system for holding the film flat, such as a vacuum table. In this manner, the film can be tensioned and placed on the vacuum table while the bond between the film and the frame is formed.

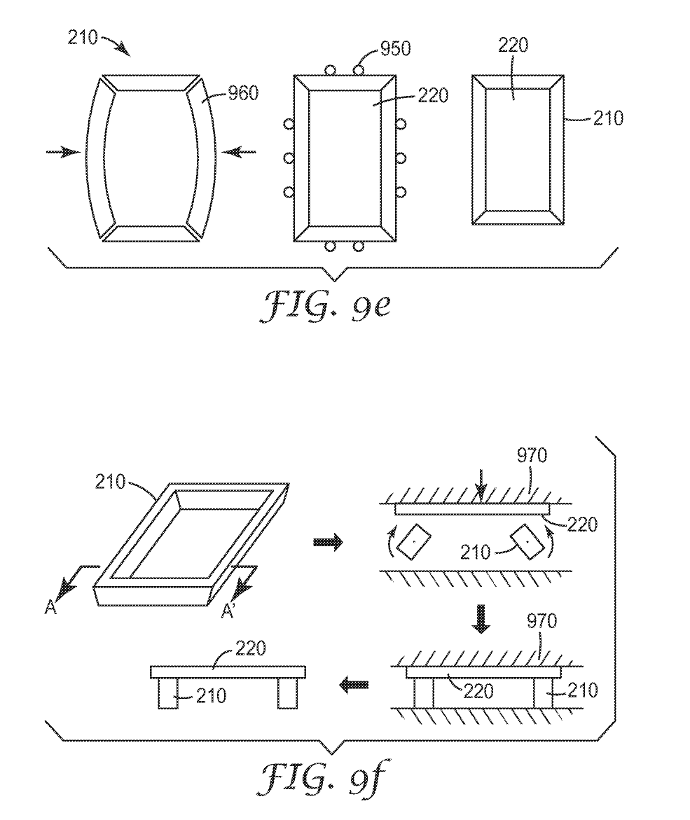

In yet another embodiment, the transmissive optical film can be held in a support prior to affixing to the frame, for example as shown in FIGS. 8a-b. In this embodiment, film support 800 is affixed to the edges of film 220 in one of the manners described above, or for example, the support can be a polymeric support that is formed in place around the film edges, while the film is held flat and in tension. The support can provide a convenient way to handle the film prior to, and during, affixation of the film to the frame via the support. The film and support can be affixed to the frame by the same methods used to affix the film to the frame as described above. In one embodiment, the support can have a feature which engages with the frame to mechanically “snap” in place, such as by use of a detent feature (not shown). In another embodiment, frame 210 can be oversized relative to support 800, so that as support 800 is affixed to the frame, further tensioning of film 220 can result. FIG. 8b shows an alternative design of the support, where a taper provided on the inside support edge can apply additional tension to the film as the support is attached to the frame by one of the methods described above.

In another embodiment, the transmissive optical film can be affixed to the frame by use of a spline as shown in FIGS. 8c-d. In this embodiment, groove 810 and spline 820 located within the periphery of frame 210 captures and affixes film 220 to the frame. Film 220 can be held in tension during attachment of the spline, alternatively, film 220 can develop tension by the action of attaching the spline. In some instances, portions 830 of film 220 can be removed from the corners as shown in FIG. 8c, to avoid wrinkling or distortion of film 220 as spline 820 is attached. FIG. 8d depicts a spline affixing films on both front and back of frame 210; however, it is to be understood that in some instances, only one film and one spline can be used.

In yet another embodiment, tension can be applied to the transmissive optical film by shrinking the film while it is affixed to the frame, for example either by heat-shrinking or by cure-shrinking the film. Heat shrinking of polymeric films can involve producing polymeric film as normal, heating it to near the polymer's glass transition temperature, and mechanically stretching the polymer (often by tentering) and then cooling the film while stretched. The heat-shrink polymer can be cross-linked, for example through the use of electron beams, peroxides or moisture, which can help to make the film maintain its shape both before and after shrinking. Upon reheating, the tendency is for the film to relax back to the original, un-stretched size. In this manner, tension develops in a stretched heat-shrink film attached to a frame, as the film is gently heated. Alternatively, the transmissive optical film can comprise a thermoset material, or more particularly a radiation curable material. If the transmissive optical film is a thermoset material, the film can be in either a fully-cured state or a partially-cured state when it is affixed to the frame. The term “fully-cured”, for the purposes of the present disclosure, means a thermoset material that has substantially no remaining reactive groups that can undergo crosslinking or chain extension. The term “partially-cured”, for the purposes of the present disclosure, means a “B-staged” material, and can be subject to further curing or crosslinking by the application of suitable heat, chemical activation, light or other radiation conditions, or a combination thereof. The process of further curing a B-staged material is generally associated with the occurrence of additional shrinkage during cure. In this manner, the B-staged material is affixed to the film frame and then subjected to additional cure. In another embodiment, the transmissive optical film comprises a fiber material that is stretched over the frame prior to coating with a thermoset polymer matrix, and subsequently cured. The film shrinkage that occurs upon curing generates the film tension that can reduce or eliminate sag and improve the rigidity of the backlight structure. Further descriptions of B-staged material can be found, for example, in U.S. Patent Publication No. 20060024482 and U.S. Pat. Nos. 6,352,782 and 6,207,726, and U.S. Provisional Application Nos. 60/947,771 and 60/947,785, filed on an even date herewith.

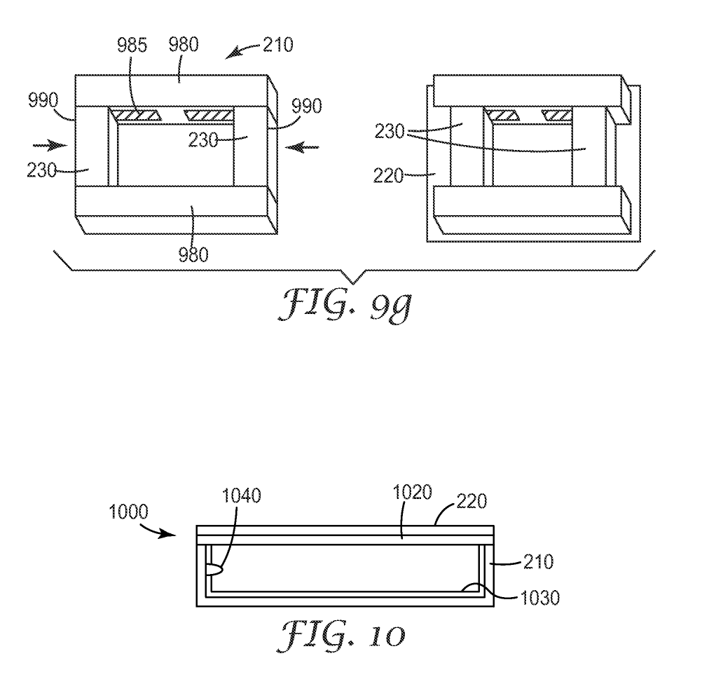

In another embodiment, the design of the frame can impart tension to the affixed film. Although film shrinkage is one method of achieving film tension in the frame, in some instances it may not be desirable for the film to shrink. For example, if the transmissive optical film is laminated to a reflective polarizer, shrinkage of the composite optical film could cause wrinkles in the reflective polarizer. Also, shrinkage of the reflective polarizer could affect the optical properties due to changes in the layer thicknesses. It may be beneficial to have assembly methods which do not require film shrinkage, but nonetheless ensure film tension. Representative examples of frame designs which can impart tension to the film are depicted in FIGS. 9a-f.

One embodiment of a film tensioning frame design is shown in FIG. 9a where frame 210 is designed to be slightly non-planar after affixing transmissive optical film 220, and before assembly into the display enclosure 30. In this manner, when the film/frame assembly is pressed flat and secured in the enclosure, the resulting dimensional change places the film in tension.

Another embodiment of a film tensioning frame design is shown in FIG. 9b where frame 210 has flexible section 900 which acts as a spring. Flexible section 900 is forced inward toward the center of cavity 240 during affixation of film 220. The force is then released, and the spring force generated by flexible section 900 serves to tension the film.

Additional embodiments of tensioning a frame prior to affixing the film are shown in FIGS. 9c-f, which are schematic views of exemplary tensioning devices. FIG. 9c is a cross-sectional schematic view of frame 210 having sides which are skewed outward prior to being inserted into assembly block 930. Upon insertion, frame 210 is elastically deformed to conform to the shape of assembly block 930, and film 220 is then affixed to frame 210 by any of the methods described previously. The film/frame assembly is removed from assembly block 930, resulting in tension applied by frame 210 to film 220 as frame 210 tends toward the original shape.

FIG. 9d is a top-view of another embodiment of film tension being applied by a frame, where untensioned frame 210 has, for example, a trapezoidal shape, and is inserted into assembly block 940, elastically compressing frame 210. Film 220 is affixed to frame 210 using any of the methods described previously. The film/frame assembly is then removed from assembly block 940, resulting in tension applied by frame 210 to film 220 as frame 210 tends toward the original shape. In this embodiment, untensioned frame 210 is oversized along at least one dimension. Upon insertion into assembly block 940, frame 210 is strained to conform to the shape of assembly block 940 prior to affixing film 220.

Another embodiment of film tension being applied to a frame is depicted in FIG. 9e, which is a schematic top-view, where frame 210 is comprised of sides 960, at least some of which are non-linear, for example curved or stepped, rather than straight. Frame 210 is forced into a rectangular shape by pins 950, prior to affixing film 220 to frame. The film/frame assembly and pins are separated, resulting in tension applied by frame 210 to film 220 as frame 210 tends toward the original shape. It is to be understood that pins, assembly blocks, or other methods known in the assembly arts, can be used to retain the frame for any of the methods described above.

Another embodiment of tensioning the frame during attachment of the film is shown in FIG. 9f. In this embodiment, the sides of frame 210 are canted relative to the front and back surfaces of the frame. Film 220 is affixed to frame 210 as sides of frame 210 are elastically twisted by, for example, press 970. It is to be understood that the sides of frame 220 can be interconnected with a spring mechanism (not shown) to develop torsion within the frame sides, or the frame material itself can be twisted to effect the torsion. Film/frame assembly is removed from press 970, resulting in tension applied by frame 210 to film 220.

Another embodiment of tensioning the frame during attachment of the film is shown in FIG. 9g. In this embodiment, frame 210 has fixed sides 980 and moveable sides 990. Fixed sides 980 have captive springs 985 which are contained in a channel within fixed sides 980. Moveable sides 990 are connected to captive springs 985, and as sides 990 are moved inward as shown, captive springs 985 compress and exert a force on moveable sides 990. Film 220 is affixed to moveable sides 990 while captive springs 985 are in compression, and resulting in tension applied to film 220.

Another embodiment of tensioning the film is shown in FIG. 9h. In this embodiment, frame 210 has fixed sides 980 and moveable corners 995. Fixed sides 980 and moveable corners 995 have captive springs 985 contained in channels. Film 220 is affixed to moveable corners 995 at affixing region 997 while captive springs 985 are forced into compression, resulting in tension applied to film 220 when the force is released.

Regardless of the method used to apply strain to (i.e. slightly deform) the frame prior to affixing the film, it is to be understood that the amount of applied strain should be below the yield strain (i.e. elastic deformation range) of the frame material, so the frame can transfer the applied strain to result in tension within the affixed film. Application of a strain greater than the yield strain can result in permanent deformation of the frame, and unsatisfactory levels of tension being developed within the film.

There are several ways to describe the ability of a structure to resist deformation. One such way is to describe the structure rigidity, which is the physical property of being stiff and resisting bending. The relative bending resistance of a structure can be determined by comparison of the torsional, rotational, or bending stiffness of one structure (in this case, a frame with an attached film) to the torsional, rotational or bending stiffness of a second structure (in this case, a frame without an attached film). In this way, changes to the design of a structure can indicate a relative increase or decrease in bending resistance that results from the change. For the purposes of this application, an increase in bending resistance is desired.

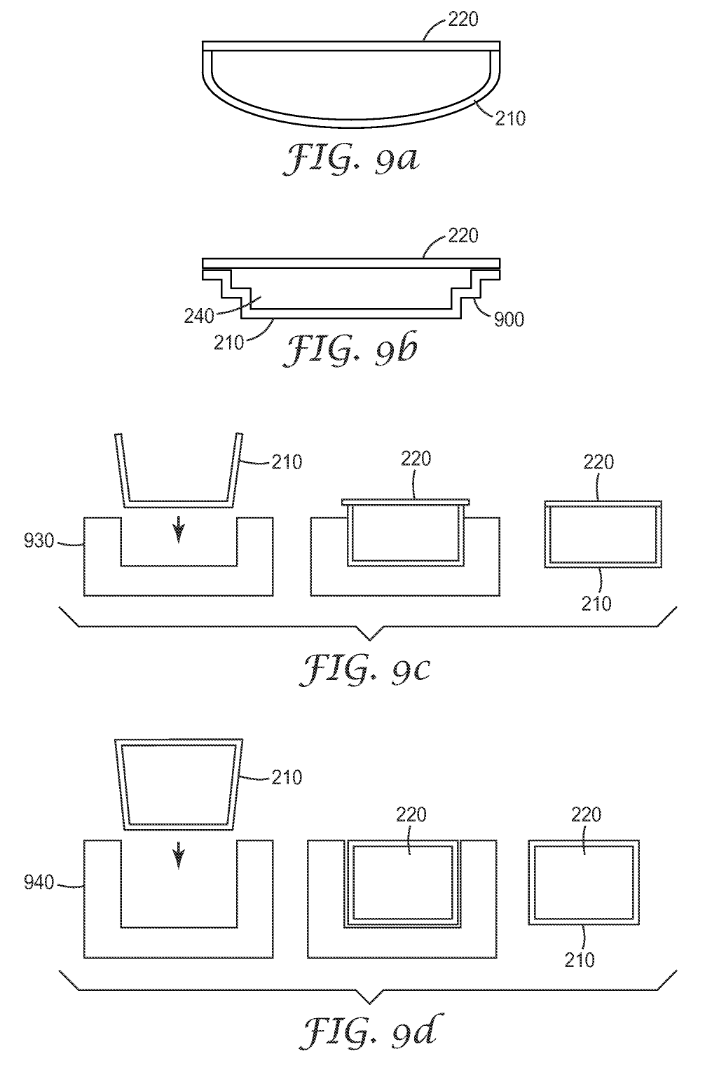

Although the description above has described with reference to increasing the bending resistance of the frame housing the backlight assembly, a result is that fragile LCD glass components do not become damaged upon application of the forces used to open, use, and close the laptop computer screen. To this end, the bending resistance of the enclosure 30 in FIG. 1a can also be increased. The same transmissive optical film affixed under tension to the enclosure, can protect the LCD against breakage. Examples of other ways to increase the bending resistance of the enclosure are shown in FIGS. 7a-c. In FIG. 7a the film is attached to the frame forming a backlight assembly which is then placed in the enclosure as described previously. In FIG. 7b, the film is attached as an internal part of the enclosure and the backlight assembly is an integral part of the enclosure. In FIG. 7c, the film is attached as part of the enclosure, and the backlight assembly is intended to encompass the entire enclosure.

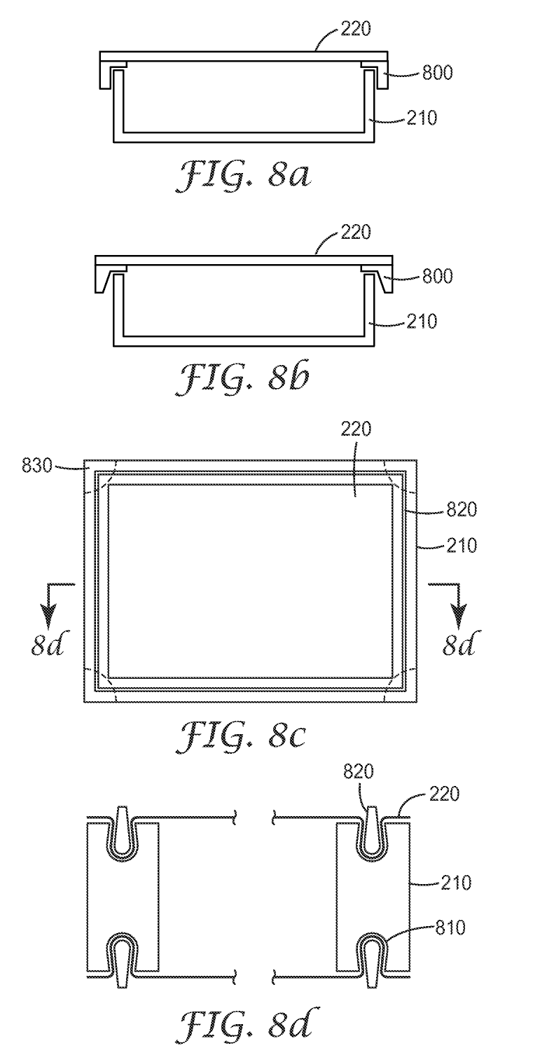

Attention is now drawn to FIG. 6, which shows a perspective view of a frame used for measuring the relative bending resistance of a backlight assembly, by evaluation of a mathematical model of the structure. In this embodiment, frame 600 is a rectangular frame having height “h”, width “w” and depth “d”. The height of the frame is defined by frame sides 610 and 620; the width of the frame is defined by sides 630 and 640. There are four frame corners, “A”, “B”, “C” and “D”, which serves both as points of reference for defining the application of forces resulting in relative movement of the corner points modeled as described in further detail below, and also to identify portions of the frame having different dimensions as further explained in the Examples. Frame 600 also has front plane 650 and back plane 660. Back plane 660 is defined by the plane passing through corners “A”, “B”, “C” and “D” and bounded by frame sides 610, 620, 630 and 640. Back plane 660 has back ledge 645 extending from frame sides 610, 620, 630 and 640. Front plane 650 is separated by the depth “d” from back plane 660, and also bounded by frame sides 610, 620, 630 and 640. For the orientation shown in FIG. 6, side 630 corresponds to the edge of enclosure 30 having a hinge 50 in FIG. 1a. Forces generating movement of frame 600 applied at frame corners “B” and “C” correspond to forces generating movement of points “P” of enclosure 20 in FIG. 1a.

A general purpose finite element analysis program (ANSYS) was used to compare the bending resistance of various frame configurations combined with various optically transmissive polymer films. In the configurations modeled, the rectangular Cartesian coordinate system as shown in FIG. 6 was used for definition of the relative motion of points encompassed by frame 600. For the purposes of the modeling, corner “A” is fixed and immovable in all coordinate directions x, y, and z. Corner “B” is fixed and immovable in coordinate directions y and z, but allowed to move in coordinate direction x. Corners “C” and “D” are imposed to move in the positive and negative z coordinate direction, such that when one of corners “C” and “D” moves in the (+)z direction, the other of corners “C” and “D” moves in the (−)z direction. In this manner, a complex torsional, rotational or bending motion occurs within frame 600, and two different frame structures can be characterized by the ratio of the stiffness, which can be described as an increased resistance to bending the frame assembly.

### EXAMPLES

The modeling examples below use the following common structure and materials. Unless otherwise noted, the transmissive optical film was a composite optical film as described , for example, in U.S. Patent Publication No. 20060257678 (Benson et al.) having a thickness of 1.5 mils (38 microns), a modulus of elasticity of 1.05×10⁴ N/mm², and a Poisson's ratio of 0.35. Also unless otherwise noted, the frame material was steel having a thickness of 0.2 mm (200 microns), a modulus of elasticity of 2×10⁵ N/mm², and a Poisson's ratio of 0.3. The dimensions of the frame modeled, referring to FIG. 6, are 270 mm, 180 mm and 2.5 mm for width “w”, height “h” and depth “d”, respectively. The back ledge 345 had a different width between different points shown in FIG. 6, and these different widths were included in the tables. For example, the ledge width between points “A” and “B” was denoted “AB”, and so on. For purposes of modeling, flange 330 shown in FIG. 3, FIG. 4, and FIG. 6, was not included in all examples for comparison purposes; however, it is to be understood that it is preferable to include a flange for affixing the film to the frame. Where the flange was included in the example, the width of the flange was constant at 2 mm. One boundary condition of the model was that there was no relative motion between the transmissive optical film and the frame within the affixing region.

### Example 1

### Modeling Results of Film on Front Plane of Frame with Varying Film Pre-Stretch and Thickness

A single transmissive optical film was affixed to the front plane of the frame. The film thickness was varied, and a “pre-stretch” (% imposed strain on film during attachment) was applied. There was no flange for this example, and the back ledge dimensions in mm were AB=10.7, BC=4, CD=5 and DA=4. The bending resistance was calculated and normalized to the frame without the affixed film, and the data is presented in Table 1.

TABLE 1

| Modeling | | | Ratio of Bending |
|---|---|---|---|
| Experiment | Film Thickness | % imposed strain | Resistance |
| 1a | Frame Only | 0 | 1 |
| 1b | 1.5 mil (38 microns) | 0 | 1.8* |
| 1c | 1.5 mil (38 microns) | 0 | 1.9 |
| 1d | 1.5 mil (38 microns) | 0.1 | 1.9 |
| 1e | 1.5 mil (38 microns) | 0.5 | 1.9 |
| 1f | 1.5 mil (38 microns) | 1.0 | 1.9 |
| 1g | 2.0 mil (51 microns) | 0 | 1.9 |
| 1h | 3.0 mil (76 microns) | 0 | 1.9 |

*The film was attached to the frame only on the top, left and right sides (i.e. not hinge side)

### Example 2

### Modeling Results of Film on Back Plane of Frame with Varying Film Pre-Stretch and Thickness

A single transmissive optical film was affixed to the back plane of the frame. The film thickness was varied, and a “pre-stretch” (% imposed strain on film during attachment) was applied. There was no flange for this example, and the back ledge dimensions in mm were AB=10.7, BC=4, CD=5 and DA=4. The bending resistance was calculated and normalized to the frame without the affixed film, and the data is presented in Table 2.

TABLE 2

| Modeling | | | Ratio of Bending |
|---|---|---|---|
| Experiment | Film Thickness | % imposed strain | Resistance |
| 2a | Frame Only | 0 | 1.0 |
| 2b | 1.5 mil (38 microns) | 0 | 1.0 |
| 2c | 1.5 mil (38 microns) | 0 | 1.0 |
| 2d | 1.5 mil (38 microns) | 0.1 | 1.0 |
| 2e | 1.5 mil (38 microns) | 0.5 | 1.0 |
| 2f | 1.5 mil (38 microns) | 1.0 | 1.0 |
| 2g | 2.0 mil (51 microns) | 0 | 1.0 |
| 2h | 3.0 mil (76 microns) | 0 | 1.0 |

### Example 3

### Modeling Results of Film on Front and Back Plane of Frame at Varying Film Pre-Stretch and Thickness

A single transmissive optical film was affixed to both the front plane and the back plane of the frame. The film thickness was varied, and a “pre-stretch” (% imposed strain on film during attachment) was applied. Both films had the same thickness and % strain for each experiment. There was no flange for this example, and the back ledge dimensions in mm were AB=10.7, BC=4, CD=5 and DA=4. The bending resistance was calculated and normalized to the frame without the affixed film, and the data is presented in Table 3.

TABLE 3

| Modeling | | | Ratio of Bending |
|---|---|---|---|
| Experiment | Film Thickness | % imposed strain | Resistance |
| 3a | Frame Only | 0 | 1 |
| 3b | 1.5 mil (38 microns) | 0 | 60 |
| 3c | 1.5 mil (38 microns) | 0.1 | 60 |
| 3d | 1.5 mil (38 microns) | 0.5 | 60 |
| 3e | 1.5 mil (38 microns) | 1.0 | 60 |
| 3f | 2.0 mil (51 microns) | 0 | 80 |
| 3g | 3.0 mil (76 microns) | 0 | 119 |
| 3h⁽¹⁾ | 1.5 mil (38 microns) | 0 | 117 |

⁽¹⁾3h was modeled with a solid sheet steel back the same thickness as the frame steel

### Example 4

### Modeling Results of Film on Front Plane of Frame with Frame Ribs and Stiffeners on Back Plane of Frame

A single transmissive optical film was affixed to the front plane of the frame. The frame design and width “r” of the ribs was varied as shown in FIGS. 3b-d. The film thickness was 1.5 mil (38 microns), and the ribs were the same material (steel) and thickness (0.2 mm) as the frame. There was no flange in any of the frame designs for this Example, and the back ledge widths in mm were varied with reference to FIG. 6, as shown in Table 4. The bending resistance was calculated and normalized to the frame without the affixed film, and the data is presented in Table 4.

TABLE 4

| Modeling | Frame | Rib Width | Ledge Width, mm | Film on Front | Ratio of Bending |
|---|---|---|---|---|---|
| Experiment | Design | (mm) | AB/BC/CD/DA | Plane (Y/N) | Resistance |
| 4a | 3a | — | 10.7/4/5/4 | N | 1 |
| 4b | 3a | — | 10.7/4/5/4 | Y | 1.9 |
| 4c | 3b | 10 | 15.7/9/10/9 | Y | 25 |
| 4d | 3b | 20 | 20.7/14/15/14 | Y | 71 |
| 4e | 3b | 30 | 25.7/24/25/24 | Y | 97 |
| 4f | 3b | 40 | 30.7/24/25/24 | Y | 108 |
| 4g⁽¹⁾ | 3a | ⁽¹⁾ | Solid Back | Y | 117 |
| 4h | 3c | 10 | 15.7/9/10/9 | Y | 101 |
| 4i | 3d | 10 | 15.7/9/10/9 | Y | 103 |
| 4j | 3c | 20 | 20.7/14/15/14 | N | 3 |
| 4k | 3c | 20 | 20.7/14/15/14 | Y | 109 |
| 4l⁽²⁾ | 3c | 10 | 15.7/9/10/9 | N | 11 |
| 4m⁽²⁾ | 3c | 10 | 15.7/9/10/9 | Y | 123 |
| 4n^{(1),(2)} | 3a | ⁽¹⁾ | Solid Back | Y | 133 |

⁽¹⁾4g and 4n were modeled with a solid sheet steel back the same thickness as the frame steel
⁽²⁾4l, 4m, 4n had added stiffener structures shown in FIG. 4b (height “s” in FIG. 4b = 1.4 mm)

### Example 5

### Modeling Results of Single Film on Front Plane of Frame with Frame Stiffeners on Back Plane of Frame

A single transmissive optical film was affixed to the front plane of the frame. The frame design was varied by adding frame stiffeners as shown in FIGS. 4a and 4b, with the depths “s” of the stiffeners set to 1.0 and 1.4 mm respectively. Additionally, the overall frame depth “d” as shown in FIG. 6 was varied. The film thickness was 1.5 mil (38 microns), and the ribs were the same material (steel) and thickness (0.2 mm) as the frame. For this Example, there was a flange having a width of 2 mm, and the back ledge dimensions in mm were AB=10.7, BC=4, CD=5 and DA=4. The bending resistance was calculated and normalized to the frame without the affixed film, and the data is presented in Table 5.

TABLE 5

| | Frame | | | |
|---|---|---|---|---|
| Modeling | Depth | Frame Stiffener | Film Used | Ratio of Bending |
| Experiment | “d” (mm) | FIG. | (Y/N) | Resistance |
| 5a | 2.5 | — | N | 1 |
| 5b | 1.1 | 4a | N | 11 |
| 5c | 1.1 | 4a | Y | 36 |
| 5d | 2.5 | 4a | N | 12 |
| 5e | 2.5 | 4a | Y | 121 |
| 5f | 2.5 | 4b | N | 12 |
| 5g | 2.5 | 4b | Y | 93 |

### Example 6

### Modeling Results of Thicker Film with Lower Modulus on Front Plane of Frame with Frame Stiffeners on Back Plane of Frame

A sample of Vikuiti™ DBEF-D400 (available from 3M Company, St. Paul, Minn.) was affixed to the frame. The thickness of the film was 0.392 mm, with a modulus of elasticity of 2318.5 N/mm², and a Poisson's ratio of 0.35. The frame had ribs as shown in FIG. 3c, and stiffeners as shown in FIG. 4b, with stiffener depth “s”=1.4 mm, rib width “r”=10 mm, and frame depth “d”=2.5 mm. For this Example, there was a flange having a width of 2 mm, and the back ledge dimensions in mm were AB=10.7, BC=4, CD=5 and DA=4. The modeling results are shown in Table 6.

TABLE 6

| | | Ratio of |
|---|---|---|
| Modeling | Film | Bending |
| Experiment | Used | Resistance |
| 6a | — | 12 [same as 5f] |
| 6b | 1.5 mil Composite | 93 [same as 5g] |
| 6c | D400 | 170 |

Prototype backlight assemblies were fabricated to experimentally demonstrate the increase in bending resistance by using a composite optical film in conjunction with a frame. The following naming conventions were used for the frames constructed and measured.
“Stock frame”—The display of a stock Fujitsu Lifebook Q2010 was disassembled. The LED light engine (backlight), LCD panel, optical film stack and back reflector were all removed leaving only the metal support frame. The metal frame was fabricated from 0.2 mm thick plated ferrous sheet metal measuring 270 mm×180 mm×2.5 mm for width “w”, height “h” and depth “d” respectively. The “Stock frame” corresponded to the design shown in FIG. 6, with back ledge 345 measuring 4 mm, with the exception that there was no flange 330 in the Stock frame.
“Fullback frame”—A frame having a solid back was fabricated from 0.2 mm thick mild steel that was annealed after being formed. The frame dimensions were the same as the Stock frame. A 2.0 mm flange surrounded the frame in order to provide a surface to for attachment of the composite optical film. The Fullback frame corresponded to the design shown in FIG. 6, with flange 345 extending across back plane 660.
“Cross-member frame”—This frame was fabricated from 0.2 mm thick mild steel that was annealed after being formed. The frame dimensions were the same as the Stock frame. Four triangular regions were cut from the solid back resulting in a cross pattern as shown in FIG. 3c, and had a 1.2 mm inward facing stiffening structure as shown in FIG. 4b. A 2.0 mm flange surrounded the frame to provide a surface to for attachment of the composite optical film.

### Composite Optical Film Preparation

The film used was a lab-prepared composite of fiberglass and polymeric resin. The fiberglass fabric used was Hexcel style 1080 with a CS-767 finish (available from Hexcel Corporation, Anderson, S.C.). The resin used to make the composite optical film was comprised of 38.95 wt % of SR247 (available from from Sartomer Company, Exton, Pa.), 60.8 wt % of RDX51027 (available from Cytec Surface Specialties, West Paterson, N.J.), and 0.25 wt % TPO photoinitiator (available from BASF, Charlotte, N.C.). The mixture of components in the resin resulted in a refractive index similar to the refractive index of the Hexcel 1080 fabric, when the resin was cured to its fullest extent.

The composite optical film was prepared by sandwiching the fabric between two sheets of unprimed 5 mil (0.127 mm) polyester film affixed to an aluminum plate, heating the resin to 55° C. and then applying the heated resin to the fabric using a pipette. The sample sandwich (consisting of the two layers of PET, fabric, resin, and the aluminum plate) was run through a Sealeze 24 hand-crank laminator (available from Southtrend Corp, Miami, Fla.) to spread the resin into contact with the fiberglass fabric. The sample sandwich was then placed in a vacuum oven at 130° C. for 4 min to remove bubbles. The sample sandwich was again run through the Sealeze laminator, resulting in a sandwich thickness of 0.33 mm and a film thickness of 0.08 mm. The resin was cured by exposing the sample sandwich at a distance of 45 mm to a 4 row×40 column array of Nichia UV LEDs powered at 7.34 Amps, and having a main output of 380 nm. The film was passed under the UV LED array four consecutive times at a line speed of 26 feet per minute, resulting in a total UVA dose of 87 mJ/cm². After the exposure to the UV LED array as described above, the composite optical film is referred to as partially cured, or “B staged”.

### Testing Fixture and Film Preparation

Frame and composite optical film combinations in the Examples were tested using a custom test fixture in combination with a Lloyd Instruments single column testing apparatus (available from Lloyd Instruments, Hants, UK). The fixture was designed to constrain frames within the boundary conditions defined by the finite element model used in their design. The fixture was an “L” shape fabricated from 10 mm thick aluminum. The fixture constrained the prototype frames in the “x”, “y” and “z” directions along the lower edge using two strips of aluminum held in place by three screws; the upper left corner was able to be displaced in the range of 0 to +5 mm in the “z” direction using a screw; the upper right corner was left unsupported such that it could be displaced in the −“z” direction using the column testing apparatus.

The composite optical films were affixed to the frames using Scotch-Weld DP100NS rigid epoxy (available from 3M Company, St. Paul, Minn.). The films were stretched using two sets of parallel bar clamps held in place using “C” clamps on opposite sides of a granite table to remove any wrinkles that were in the film. The frame was wiped with isopropyl alcohol, and the epoxy was applied in a fine line to the flange of the steel frame using a Scotch-Weld EPX Plus II Applicator and 3M Scotch-Weld EPX Plus II Mixing Square Nozzle (Gold), (both available from 3M Company, St. Paul, Minn.). The adhesive was then smeared out using a gloved finger to ensure the entire lip of the frame was covered. The frame was then applied to the film and held in place along the edges until the adhesive became tacky. Prior to mechanical testing, the adhesive was allowed to cure overnight.

### Comparative Example 1

### Fujitsu Lifebook Q2010 Display

The displacement of the display of a stock, unmodified Fujitsu Lifebook Q2010 was measured in order to obtain a load baseline. For this measurement, the bottom of the laptop display was constrained to the test fixture using a pair of C-clamps. C-clamps were also used to constrain the hinges of the laptop and the top left corner of the display to the test fixture to ensure there was no movement of the laptop other than the top right corner of the display. The load cell of the column tester was positioned adjacent the top right corner of the display so that it was in contact with the display, with no load applied. A load was applied until a displacement of −5 mm was measured. During application of the load, both the load and displacement were recorded using Nexygen FM Plus software. A load of 2.52 N was measured for a displacement of −5 mm.

### Comparative Example 2

### Stock Fujitsu Display Frame

The Stock frame described above was constrained along the bottom edge using the test fixture. The top left corner was displaced +5 mm in the z-direction using the set screw prior to the measurement. A load was applied to the top right corner until it was displaced −5 mm. During application of the load, both the load and displacement were recorded using Nexygen FM Plus software. A load of 0.031 N was measured for a total displacement of 10 mm.

### Example 7

### Bare Cross-Member Frame

A Cross-member frame described above, was secured along the bottom edge using the test fixture, and the set screw was used to deflect the upper left corner of the frame +5 mm in the z-direction. The load cell of the column testing apparatus was positioned adjacent the frame such that there was a minimal gap between the cell and the frame, with no load applied. A load was then applied to the top right corner until it was displaced −5 mm. During application of the load, both the load and displacement were recorded using Nexygen FM Plus software. A load of 0.45418 N was measured for a total displacement of 10 mm. This represented a factor of 14.65 bending resistance increase over the Stock frame.

### Example 8

### Bare Fullback Frame

A Fullback frame was secured along the bottom edge using the test fixture, and the set screw was used to deflect the upper left corner of the frame +5 mm in the z-direction. The load cell of the column testing apparatus was positioned adjacent the frame such that there was a minimal gap between the cell and the frame, with no load applied. A load was applied to the top right corner until it was displaced −5 mm. During application of the load, both the load and displacement were recorded using Nexygen FM Plus software. A load of 1.1106 N was measured for a total displacement of 10 mm. This represented a factor of 32.83 bending resistance increase over the Stock frame.

### Example 9

### Cross-Member Frame with Composite Optical Film and Acrylic Spacers

A Cross-member frame was fitted with a piece of acrylic, used to simulate the backlight found in the Fujitsu display, to simulate a backlight assembly. The acrylic sheet was cut to the same dimensions as the backlight and dropped in the frame. A piece of the “B staged” composite optical film was affixed to a Cross-member frame as described above, sealing the acrylic spacer in the cavity between the film and cross members of the frame. The simulated backlight assembly was then cured under a Fusion UV lamp D-bulb (available from Fusion UV Systems Inc., Gaithersburg, Md.) at 100% power using 3 passes at a speed of 25 ft/min (12.7 cm/sec) to complete the polymerization of the resin in the composite optical film. The completion of the polymerization effected shrinkage of the film and tensioning the film on the frame. The dosage of the UV light on the sample is shown in Table 7.

TABLE 7

| UV Channel | Dosage per Pass | Total Sample Dosage | Intensity |
|---|---|---|---|
| UVA | 2149 mJ/cm² | 6447 mJ/cm² | 8635 mW/cm² |
| UVB | 633 mJ/cm² | 1899 mJ/cm² | 2753 mW/cm² |
| UVC | 46.4 mJ/cm² | 139.2 mJ/cm² | 205 mW/cm² |
| UVV | 363 mJ/cm² | 1089 mJ/cm² | 5565 mW/cm² |

The simulated backlight assembly was secured along the bottom edge using the test fixture, and the set screw was used to deflect the upper left corner of the frame +5 mm in the z-direction. The load cell of the column testing apparatus was positioned adjacent the frame such that there was a minimal gap between the cell and the frame, with no load applied. A load was applied to the top right corner until it was displaced −5 mm. During application of the load, both the load and displacement were recorded using Nexygen FM Plus software. A load of 1.3 N was measured for a total displacement of 10 mm. This represented a factor of 43 bending resistance increase over the Stock frame.

### Example 10

### Fujitsu with Cross-Member Frame, Partially Cured Film and Acrylic Spacers

A Cross-member frame was fitted with a piece of acrylic, used to simulate the backlight found in the Fujitsu display, to simulate a backlight assembly. The acrylic sheet was cut to the same dimensions as the backlight and dropped in the frame. A piece of “B staged” composite optical film was applied to a Cross-member frame as described above. A single sheet of Corning Eagle flat panel display glass (available from Corning Inc., Corning, N.Y.) that was approximately the same thickness as the two pieces of glass and liquid crystal material that made up the original Fujitsu LCD panel, was used to simulate the display. The simulated backlight assembly was cured as described in Example 9.

The unit was secured along the bottom edge using the test fixture, and constrained in the test fixture as described previously in Comparative Example 1. The load cell of the column testing apparatus was positioned adjacent the frame such that there was a minimal gap between the cell and the frame, with no load applied. A load was applied to the top right corner until it was displaced −5 mm. During application of the load, both the load and displacement were recorded using Nexygen FM Plus software. A load of 5.5504 N was measured for a total displacement of 5 mm. This represents a factor of 2.2 bending resistance increase over the original laptop.

The invention described above can be applied anywhere that thin, optically transmissive structures are used, including displays such as TV, notebook and monitors, and used for advertising, information display or lighting. The present disclosure is also applicable to electronic devices including laptop computers and handheld devices such as Personal Data Assistants (PDAs), personal gaming devices, cellphones, personal media players, handheld computers and the like, which incorporate optical displays. The light sources used in the backlight assembly can be, for example, cold cathode fluorescent (CCFL), high color gamut CCFL, LED, and other sources can be used.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A backlight assembly, comprising:
a backlight having a first surface;
a frame surrounding at least a portion of the backlight; and
a transmissive optical film adjacent the first surface of the backlight and affixed to the frame, so as to provide an increased bending resistance to the frame.

2. The backlight assembly of claim 1, wherein the bending resistance of the frame is increased by at least a factor of 10.

3. A liquid crystal display comprising the backlight assembly of claim 1.

4. The liquid crystal display of claim 3, wherein a bending resistance of the display is increased by at least a factor of 2.

5. The backlight assembly of claim 1, wherein the transmissive optical film comprises a composite optical film.

6. The backlight assembly of claim 1, wherein the backlight has an aspect ratio greater than 20.

7. The backlight assembly of claim 1, wherein the frame comprises a base, positioned opposite the first surface of the backlight.

8. The backlight assembly of claim 7, wherein the base further comprises at least one structural supporting rib.

9. The backlight assembly of claim 7, further comprising a polymeric film affixed to the base.

10. A backlight assembly, comprising:
a backlight having a first surface;
a frame surrounding at least a portion of the backlight; and
a transmissive optical film adjacent the first surface of the backlight and affixed to the frame, wherein the transmissive optical film affixed to the frame is in tension so as to provide an increased bending resistance to the frame.

11. A light emitting panel comprising the backlight assembly of claim 10.

12. The backlight assembly of claim 10, wherein the transmissive optical film is held in tension prior to being affixed to the frame.

13. The backlight assembly of claim 10, wherein the frame applies tension to the transmissive optical film after affixation to the frame.

14. The backlight assembly of claim 10, wherein the transmissive optical film exerts a tensile force on the frame after being affixed to the frame.

15. The backlight assembly of claim 10, wherein the backlight has an aspect ratio greater than 20.

16. The backlight assembly of claim 10, wherein the frame comprises a base, positioned opposite the first surface of the backlight.

17. The backlight assembly of claim 16, wherein the base further comprises at least one structural supporting rib.

18. The backlight assembly of claim 16, further comprising a polymeric film affixed to the base.

19. The backlight assembly of claim 10, wherein the bending resistance of the frame is increased by a factor of 10.

20. A liquid crystal display comprising the backlight assembly of claim 10.

21. The liquid crystal display of claim 20, wherein the bending resistance of the display is increased by at least a factor of 2.

22. The backlight assembly of claim 10, wherein the transmissive optical film comprises a composite optical film.

23. The backlight assembly of claim 10, wherein the transmissive optical film further comprises at least one film selected from a polarizer, a reflective polarizer, a diffuser, a reflector, a partial reflector, an asymmetric reflector, and a structured surface film.

24. A backlight assembly, comprising:
a backlight having a first surface;
a frame surrounding at least a portion of the backlight; and
a composite optical film adjacent the first surface of the backlight, and affixed to the frame.

25. The backlight assembly of claim 24, wherein the film is affixed to the frame using an adhesive.

26. The backlight assembly of claim 25, wherein the adhesive is selected from a hotmelt adhesive, an epoxy adhesive, and a reactive polyurethane adhesive.

27. The backlight assembly of claim 24, wherein the composite optical film comprises fibers.

28. The backlight assembly of claim 27, wherein the fibers are woven.

29. The backlight assembly of claim 27, wherein the fibers are inorganic fibers.

30. The backlight assembly of claim 29, wherein the inorganic fibers are selected from glass, ceramic, and glass-ceramic.

31. The backlight assembly of claim 24, wherein the composite optical film comprises a thermoset polymer.

32. The backlight assembly of claim 24, wherein the composite optical film is a laminate.

33. The backlight assembly of claim 32, wherein the laminate comprises a multilayer optical film.

34. The backlight assembly of claim 32, wherein the laminate comprises a birefringent film.

35. The backlight assembly of claim 32, wherein the laminate comprises an asymmetric reflective film.

36. The backlight assembly of claim 24, wherein the composite optical film comprises at least one microstructured surface.

37. A liquid crystal display comprising the backlight assembly of claim 24.

38. A luminaire comprising the backlight assembly of claim 24.

39. A sign comprising the backlight assembly of claim 24.

40. A method of making a light emitting panel, comprising:
providing a frame comprising a top opening and a perimeter;
placing at least a portion of a planar light source within the frame;
affixing a transmissive optical film across the top opening of the frame, wherein the transmissive optical film is affixed along the perimeter and held in tension across the opening.

41. A method of making a liquid crystal display, comprising:
providing a frame comprising a top opening and a perimeter;
placing at least a portion of a planar light source within the frame;
affixing a transmissive optical film across the top opening of the frame, wherein the transmissive optical film is affixed along the perimeter and held in tension across the opening; and
positioning a liquid crystal display module adjacent the planar light source.

42. A hollow backlight assembly, comprising:
a light source;
a frame surrounding at least a portion of the light source, the frame having a reflective surface adjacent the light source and a first opening;
an asymmetric reflective film positioned over the opening; and
a transmissive optical film adjacent the asymmetric reflective film and affixed to the frame, so as to provide an increased bending resistance to the frame.

43. The hollow backlight assembly of claim 42, wherein the frame further comprises an optical element configured to direct light from the light source in a direction substantially parallel to the first opening.

44. The hollow backlight assembly of claim 43, wherein the optical element is selected from a baffle, a wedge, a parabola, a paraboloid and a compound parabolic concentrator.
